(19) United States
(12) Patent Application Publication
(10) Pub. No.: US 2010/0229129 A1
(43) Pub. Date: Sep. 9, 2010

(54) CREATING ORGANIZATIONAL CONTAINERS ON A GRAPHICAL USER INTERFACE

(75) Inventors: Edward Price, Redmond, WA (US); Nicole Coddington, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/398,018

(22) Filed: Mar. 4, 2009

(51) Int. Cl. G06F 3/033

(52) U.S. Cl. 715/863

(57) ABSTRACT

Embodiments related to the formation of an organizational container on a touch-sensitive graphical user interface are disclosed. One disclosed embodiment provides a method of forming an organizational container comprising receiving a touch gesture at the graphical user interface, the touch gesture defining a set of zero or more content items to be grouped together and further defining a region of the touch-sensitive graphical user interface. The method further comprises forming an organizational container responsive to receiving the touch gesture at the touch-sensitive graphical user interface, presenting a boundary defining the organizational container, moving the set of content items into the organizational container, and presenting the set of content items arranged within the boundary according to an organized view.

### BACKGROUND

Touch-sensitive graphical user interfaces of computing devices are capable of presenting graphical content and receiving one or more touch inputs from fingers, styluses, and/or other suitable objects in order to manipulate the graphical content. Such touch-sensitive graphical user interfaces may include a display system that is configured to display the graphical content to a user, and a touch input device that is configured to detect one or more touch inputs on a display surface. Various types of touch input devices are known, including but not limited to capacitive, resistive and optical mechanisms.

The use of a touch-sensitive graphical user interface may enable the utilization of a broader range of touch-based inputs than other user input devices. However, current pointer-based graphical user interfaces configured for use with a mouse or other cursor control device may not be configured to utilize the capabilities of modern touch-sensitive devices.

### SUMMARY

Accordingly, various embodiments related to the manipulation of content items on a touch-sensitive graphical user interface are disclosed herein. For example, one disclosed embodiment provides a method of organizing content items presented on a touch-sensitive graphical user interface. The method comprises receiving a touch gesture at the touch-sensitive graphical user interface, the touch gesture defining a set of zero or more content items to be grouped together and further defining a region of the touch-sensitive graphical user interface. The method further comprises forming an organizational container responsive to receiving the touch gesture at the touch-sensitive graphical user interface and presenting a boundary that defines the organizational container. The method further comprises moving the set of content items into the organizational container and presenting the set of content items on the touch-sensitive graphical user interface within the boundary defining the organizational container. The set of content items may be arranged within the boundary according to an organized view.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram of an embodiment of a computing device including a touch-sensitive graphical user interface.

FIG. 2 shows a process flow depicting an embodiment of a method of organizing content items presented on a touch-sensitive graphical user interface according to an embodiment of the present disclosure.

FIG. 3 shows a process flow depicting an embodiment of a method for evaluating whether an organizational container is to be formed responsive to a touch gesture.

FIG. 4 shows an example embodiment of a touch gesture for defining a set of content items and defining a region of a touch-sensitive graphical user interface for forming an organizational container.

FIGS. 5 and 6 show example embodiments of boundaries defining organizational containers.

FIGS. 7-14 show other example embodiments touch gestures for defining a set of content items and defining a region of a touch-sensitive graphical user interface for forming an organizational container.

FIG. 15 shows an example embodiment of a touch gesture for moving a set of content items into an organizational container.

### DETAILED DESCRIPTION

Various embodiments are disclosed herein that relate to the operation of a touch-sensitive graphical user interface. As mentioned above, many touch-sensitive graphical user interfaces for computing devices may not be configured to exploit the capabilities offered by a touch-sensitive use environment that may allow for a richer user experience. Before discussing the touch-sensitive graphical user interface-related embodiments disclosed herein, an example touch-sensitive graphical user interface environment is described.

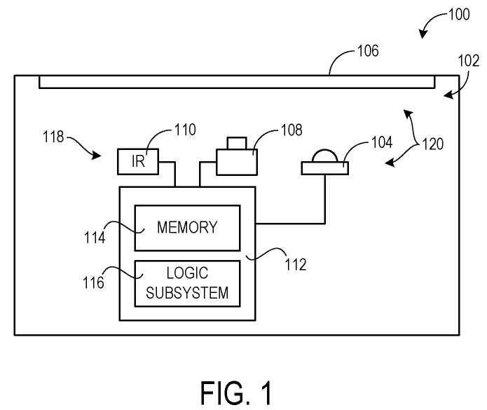

FIG. 1 shows an embodiment of an example computing device 100 in the form of a surface computing device including a touch-sensitive graphical user interface 102. In the particular embodiment of FIG. 1, touch-sensitive graphical user interface 102 utilizes an optical based approach for detecting a touch input (e.g., a touch gesture). However, it should be appreciated that a touch-sensitive graphical user interface may use resistive or capacitive based approaches as an alternative to or in addition to the optical based approach of FIG. 1.

Touch-sensitive graphical user interface 102 includes a display system 120 configured to present graphical content. Display system 120 includes a display surface 106 and an image source 104. As a non-limiting example, image source 104 may include a projection device configured to present an image (e.g., graphical content) on display surface 106.

Touch-sensitive graphical user interface 102 further includes a touch input device 118 configured to receive a touch gesture responsive to an object contacting display surface 106 of display system 120. Touch input device 118 may include an image sensor 108 for acquiring an infrared image of the display surface 106 to detect objects, such as fingers, touching or contacting the display surface 106. The display surface 106 may comprise various structures such as diffuser layers, anti-glare layers, etc. not shown in detail herein. The touch input device may further include an illuminant 110, depicted herein as an infrared light source, configured to illuminate a backside of the display surface 106 with infrared light.

Through operation of one or more of the image source 104, the image sensor 108, and the illuminant 110, the touch-sensitive graphical user interface may be configured to detect one or more touches contacting display surface 106. In some embodiments, touch input device 118 may be configured to detect and distinguish multiple temporally overlapping touches on display surface 106, herein referred to as a multi-touch input (e.g., a multi-touch gesture). For example, infrared light from the illuminant 110 may be reflected by objects contacting display surface 106, and then detected by image sensor 108 to allow detection of one or more objects on display surface 106. An optical filter (not shown) may be used to reduce or prevent unwanted wavelengths of light from reaching image sensor 108. While the depicted embodiment comprises a single image sensor 108, it will be understood that a touch-sensitive graphical user interface may have any suitable number of image sensors which each may detect a portion of the display surface 106, or an entire area of the display surface 106.

Computing device 100 further comprises a controller 112 having memory 114 and a logic subsystem 116. Logic subsystem 116 may include one or more processors. Memory 114 may comprise instructions (e.g., one or more programs) executable by the logic subsystem 116 to operate the various components of computing device 100. For example, memory 114 may comprise instructions executable by the logic subsystem 116 to operate display system 120 and the touch input device 118 to receive a touch gesture at the touch input device.

As will be described in greater detail with reference to the following figures, the touch gesture may define a set of content items to be grouped together within an organizational container and may further define a region of the display surface where the organizational container may be formed. The term “content items” as used herein refers to the representation of a content item on a graphical user display, and may include representations of any suitable type of content, including but not limited to electronic files, documents, images, audio, video, software applications, etc.

Memory 114 may further comprise instructions executable by the logic subsystem 116 to operate display system 120 and the touch input device 118 to form an organizational container responsive to receiving the touch gesture at the touch input device. The term “organizational container” as used herein signifies a dynamic grouping mechanism where content (such as cards, photos, videos, albums, etc.) is added to the container and organized within the container. Unlike folders, organizational containers allow a user to view the content and manipulate the content and the containers in various interactive ways.

For example, where a set of content items is associated with an organizational container, for example, by moving the set of content items into the organizational container, the set of content items may be controlled or navigated as a group or individually, depending upon the input gestures used. As another example, if an action is applied to the organizational container by a user the action may be applied to each content item within that organizational container. As yet another example, a user may navigate the set of content items to a different location of the display surface by dragging and dropping the organizational container.

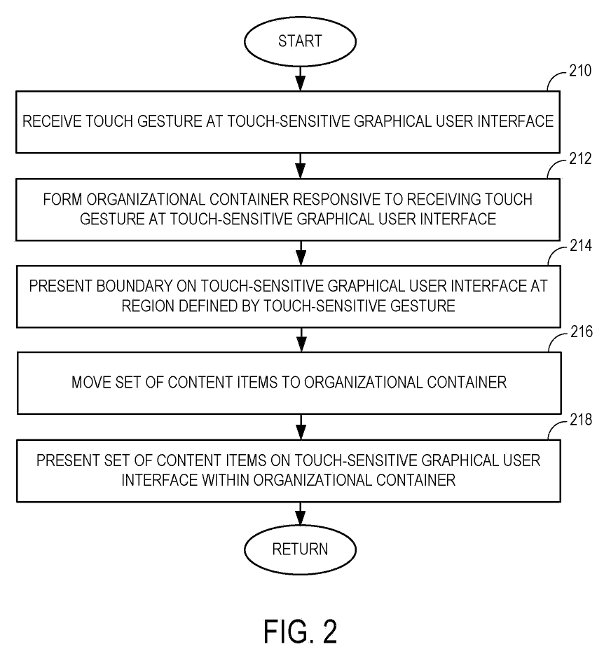

FIG. 2 shows a process flow depicting an embodiment of a method of organizing content items presented on a touch-sensitive graphical user interface. It should be appreciated that the process flow of FIG. 2 may be performed by computing device 100 of FIG. 1, or any other suitable computing devices including a touch-sensitive display and graphical user interface.

At 210, the method includes receiving a touch gesture at the touch-sensitive graphical user interface. Next, at 212, the method comprises forming an organizational container in response to the receipt of the touch input and, at 214, presenting a boundary on the touch-sensitive graphical user interface at the region defined by the touch gesture, wherein the boundary defines the organizational container. The method next comprises, at 216, moving a set of content items into the organizational container, and then, at 218, presenting the set of content items on the graphical user interface within the organizational container in an organized view. In this manner, a user may organize content (e.g., represented as content items) displayed on a graphical user interface with simple, intuitive gestures. The content may then be manipulated in other manners via the manipulation of the organizational container. For example, a user may use the organizational container to present a slideshow of movies and/or videos contained within the organizational container. It will be understood that this example of a use of an organizational container is presented for the purpose of example, and is not intended to be limiting in any manner.

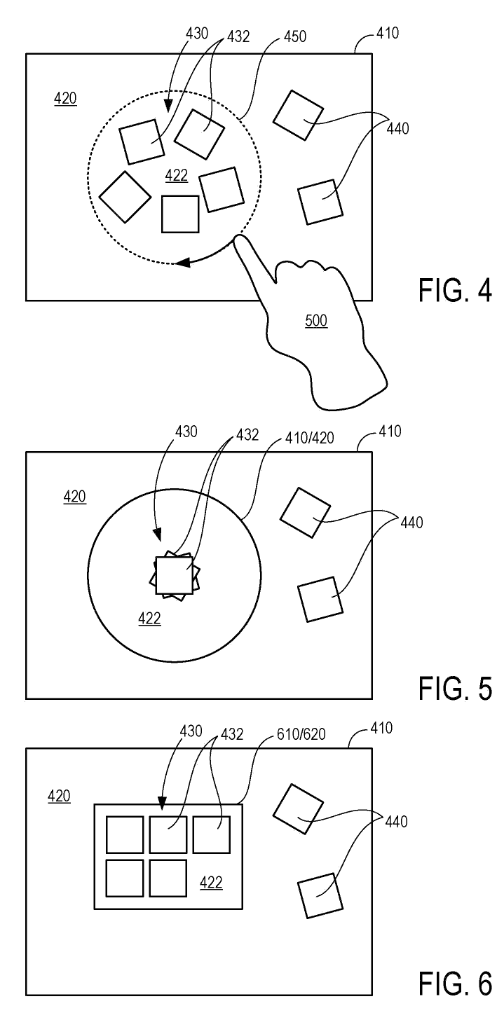

The touch gesture received at 210 may be defined by a path of travel of an object contacting the touch-sensitive graphical user interface (e.g., display surface 106). In some embodiments, the touch gesture defines a set of zero or more content items to be grouped together in the organizational container. For example, referring to FIG. 4, a set of content items 430 is defined by path of travel 450 of object 400, and includes five content items 432 that are substantially surrounded by path of travel 450. The term “substantially surrounds” as used herein comprises, for example, touch gestures that form a complete closed loop around one or more content items, or that form a shape (such as a letter “c”) that can be computationally completed to form a closed loop around a content item or items. In other embodiments discussed below, other gestures may be used to define a set of content items 430 for inclusion in an organizational container.

The touch gesture received at 210 also may define a region of the touch-sensitive graphical user interface (e.g., a region of display surface 106) at or near which the organization container is to be formed. For example, such a region is shown at 452 in FIG. 4 as a region of a background canvas 420 encircled by the path of travel 450. In this example, the organizational container may be formed about a geometric center of the area defined by the path of travel 450, or in any other suitable relation to the path of travel 450. In some embodiments, the organizational container may be formed near the region defined by the touch gesture. For example, one or more points located along the path of travel of the object may define an edge of the organizational container. As another example, a center point of the organizational container may be formed at a geometric center of the path of travel of the object defining the touch gesture. It will be understood that these embodiments are presented for the purpose of example, and are not intended to be limiting in any manner.

As mentioned above, the touch inputs described herein to form an organizational container may be configured to be intuitive gestures that are similar to physical gestures used to perform similar physical tasks. For example, referring to FIG. 4, the path of travel 450 defining the touch gesture is a circle or ellipse that encircles the content items to be included in the organizational container. Path of travel 450 may be described as a “lassoing” or encircling gesture, where content items are grouped by the touch gesture via a gesture that is physically and conceptually similar to the grouping of physical objects by a lasso or the like.

The organizational container formed at process 212 of FIG. 2 may have any suitable shape and appearance. FIGS. 5 and 6 show example organizational containers 510 and 610 that may be formed at or near region 522 defined by the touch gesture received at 210, where container 510 has a circular shape and container 610 has a rectangular shape. In some embodiments, the area within a container may have a similar appearance to the area outside of the container, while in other embodiments the area within the container may have a different appearance. The shape of the organizational container may correspond to the shape of the touch input made, or may correspond to a predetermined shape.

As described above, a boundary may be displayed around a perimeter of an organizational container to illustrate the location and shape of the container to a user more clearly. Such a boundary may have any suitable appearance. For example, the boundary may be displayed as a sharp line, a diffuse aura, or in any other suitable form. Further, the boundary may extend around the entire perimeter of an organizational container, or only a portion of the container. Furthermore, in some embodiments, a background canvas 420 presented on the graphical user interface may be exposed to a user in an internal region of the boundary such that the canvas is visible within the organizational container.

The organizational containers shown in FIGS. 5 and 6 show two examples of the presentation of a set of content items in an organized view. First, in FIG. 5, a set of content items is organized in a stacked view. Next, in FIG. 6, a set of content items is organized in a grid view. It will be understood that these embodiments are shown for the purpose of example, and that content items may be displayed in any other suitable organized view. Further, the term “organized view” does not imply that a view is organized according to a regular pattern, as the display of content items in a random array in an organizational container may be considered an “organized view” in that the content items are organized randomly relative to one another but organized separately from content items outside of the organizational container.

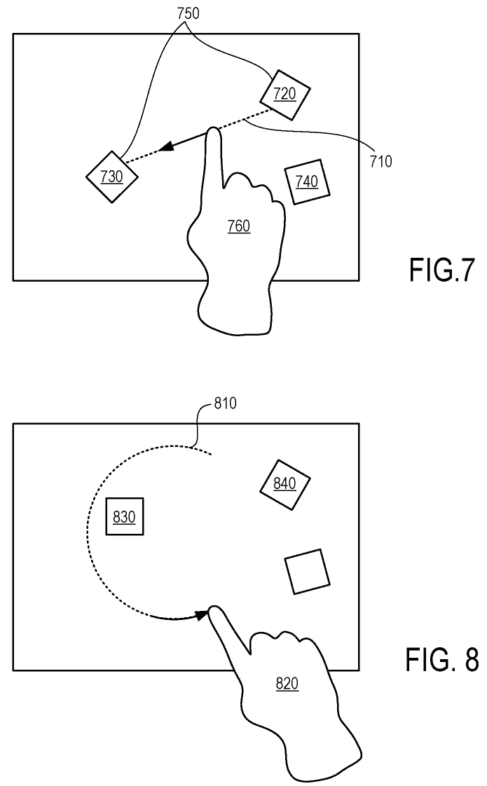

In other embodiments, instead of defining a set of content items and forming an organizational container with those items by substantially surrounding the items with a touch gesture, a set of content items may be defined and an organizational container may be formed by defining a path of travel between two or more content items on the touch-sensitive display. FIG. 7 shows an example embodiment of a gesture configured to define a set of content items 750 by defining a path of travel 710 between a first content item 720 and a second content item 730, thereby defining a set of content items 750. In this example, content item 740 is excluded from the set of content items 750, as it is not linked to the others via a touch gesture.

In yet other embodiments, an organizational container may be formed by making a touch input that defines a path of travel that corresponds to a recognized gesture. A recognized gesture may include a symbol, a geometric shape, an alphanumeric character, or a gesture defined by a specified action. For example, an alphanumeric character may include an alphabetic character (e.g., a letter), a numerical character (e.g., a digit), or any other suitable character. A geometric shape may include a line, a circle, a semi-circle, an ellipse, a polygon (e.g., a triangle, square, rectangle, etc.), or other suitable geometric shape. It should be appreciated that a geometric shape may include closed, open, or substantially closed forms that are defined by the path of travel of an object contacting the display surface. A symbol may include a swirl, an arrow, or other suitable symbol. Likewise, an action may include a characteristic rubbing action of the touch-sensitive graphical user interface or a tapping of the touch-sensitive graphical user interface, or other suitable action.

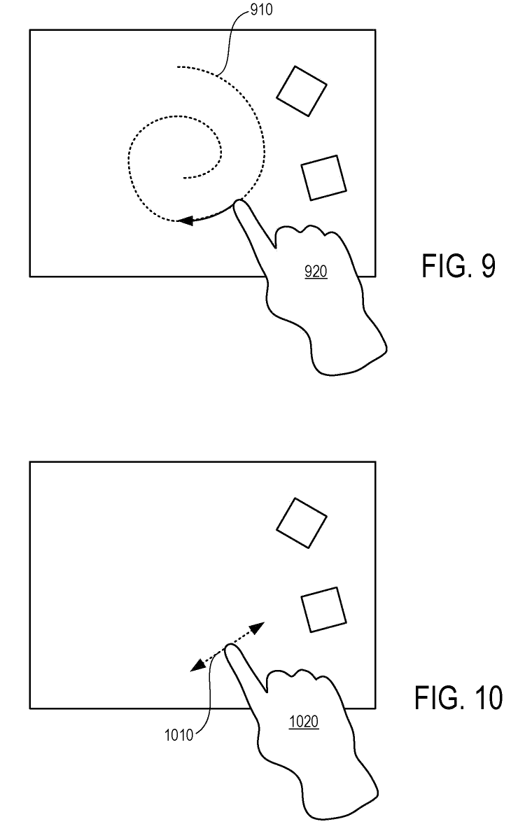

As examples, FIG. 8 depicts a path of travel 810 of an object 820 including an alphanumeric character (e.g., an alphabetic letter “C”). FIG. 9 depicts a path of travel 910 of object 920 defining a touch gesture including a symbol (e.g., a swirl). FIG. 10 depicts a path of travel 1010 of object 1020 defining a characteristic rubbing action.

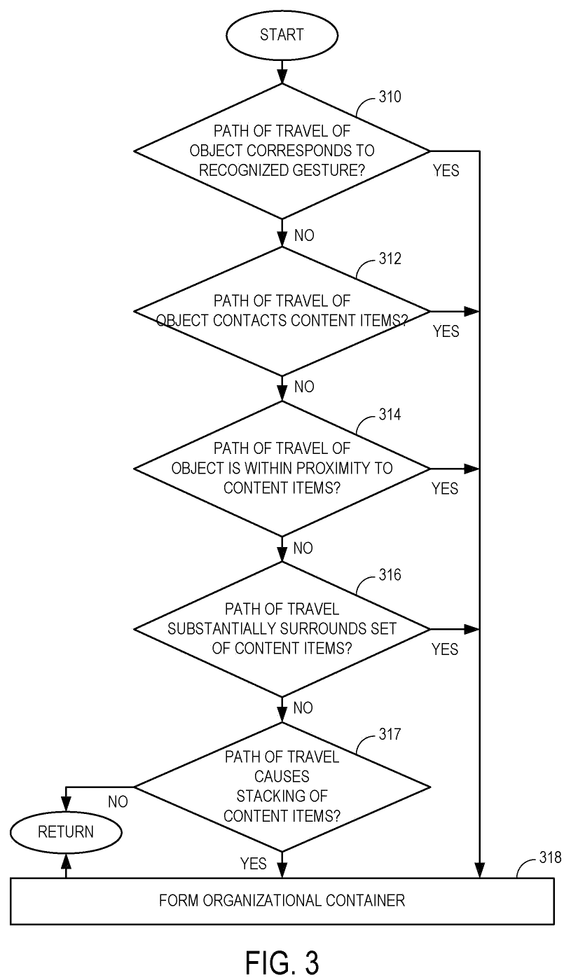

Each of these methods of forming an organizational container may involve comparing a received touch input gesture to one or more expected touch input gesture, and then determining if the path of travel of the received touch input gesture matches an expected touch. FIG. 3 shows a process flow depicting an embodiment of a method for evaluating whether an organizational container is to be formed responsive to a touch gesture. The process flow of FIG. 3 incorporates various different embodiments of gestures for forming an organizational container discussed herein. However, it will be understood that other embodiments may utilize only a subset of the illustrated gestures, or may utilize any other suitable gesture. Further, it will be understood that the order in which the processes of FIG. 3 are illustrated is shown for the purpose of example, and is not intended to be limiting in any manner.

The method of FIG. 3 first comprises, at 310, determining whether the path of travel of the object contacting the touch-sensitive graphical user interface corresponds to a recognized gesture (i.e. symbol, etc.) for the formation of an organizational container. If the answer at 310 is judged yes, the process flow may proceed to 318, where an organizational container is formed.

Alternatively, if the answer at 310 is judged no, the process flow may instead proceed to 312 where it is determined whether the path of travel of the object contacts one or more content items displayed on the graphical user interface. If the answer at 312 is judged yes, the process flow may proceed to 318 where the organizational container may be formed.

Alternatively, if the answer at 312 is judged no, the process flow may instead proceed to 314 where it may be judged whether the path of travel of the object is within a threshold proximity to one or more content items of the set of content items. If the answer at 314 is judged yes, the process flow may proceed to 318 where the organizational container may be formed.

Alternatively, if the answer at 314 is judged no, the process flow may instead proceed to 316 where it may be judged whether the path of travel substantially surrounds the set of content items. For example, referring again to FIG. 8, path of travel 810 substantially surrounds content item 830 but does not substantially surround content item 840. If the answer at 316 is judged yes, the process flow may proceed to 318 where the organizational container may be formed.

Alternatively, if the answer at 316 is judged no, then the method proceeds to 317, where it is determined whether the path of travel of the touch gesture causes a movement of two or more content items into an overlapping arrangement on the graphical user interface. If the path of travel does cause a movement of two or more content items into an overlapping arrangement, then an organizational container is formed if the number of content items in the overlapping arrangement exceeds a threshold number of overlapping content items. On the other hand, if the path of travel does not cause a movement of content items into an overlapping arrangement where the number of overlapping content items exceeds the threshold number of overlapping content items, then the process flow may return or end.

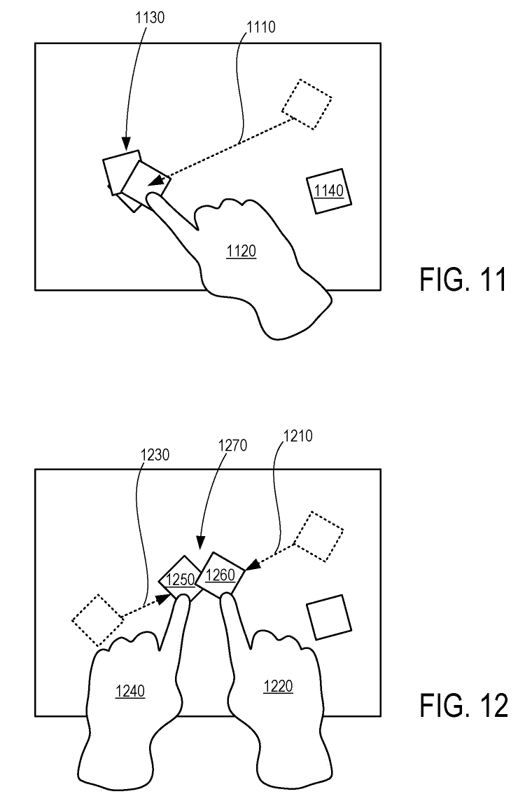

Any suitable value may be used for the threshold number of overlapping content items to form an organizational container. For example, FIGS. 11 and 12 illustrate examples of embodiments of touch gestures in which the path of travel causes a movement of two or more items into an overlapping arrangement. First referring to FIG. 11, a single-touch gesture is used to add a third content item to a previously-formed overlapping arrangement of two content items via a drag-and-drop gesture to form an organizational container. The single-touch gesture is defined by a path of travel 1110 of an object 1120 that moves a content item to form an arrangement 1130 of three overlapping content items. In the depicted embodiment, the threshold number of overlapping content items is two, such that only arrangements of three or more overlapping items trigger the formation of an organizational container, with the overlapping items defined as the set of items included in the container. The use of a higher threshold number may be helpful, for example, where a gesture (such as a single-touch drag and drop) may cause the inadvertent overlapping of content items during the movement. Note that, in the example of FIG. 11, item 1240 is not to be included in the organizational container.

Next referring to FIG. 12, a multi-touch input is illustrated including a first touch and a second touch via objects 1220 and 1240 that move first content item 1260 and a second content item 1250 via a first path of travel 1210 and a second path of travel 1230 into an overlapping arrangement. The term “multi-touch” as used herein refers to two or more temporally overlapping touch inputs. As depicted, the threshold number of overlapping content items is one, such that any arrangement of two or more overlapping items causes the formation of an organizational container. The use of a relatively lower threshold number may be helpful, for example, where a gesture (such as a multi-touch gesture that pushes two object toward each other) poses less risk of inadvertent overlapping.

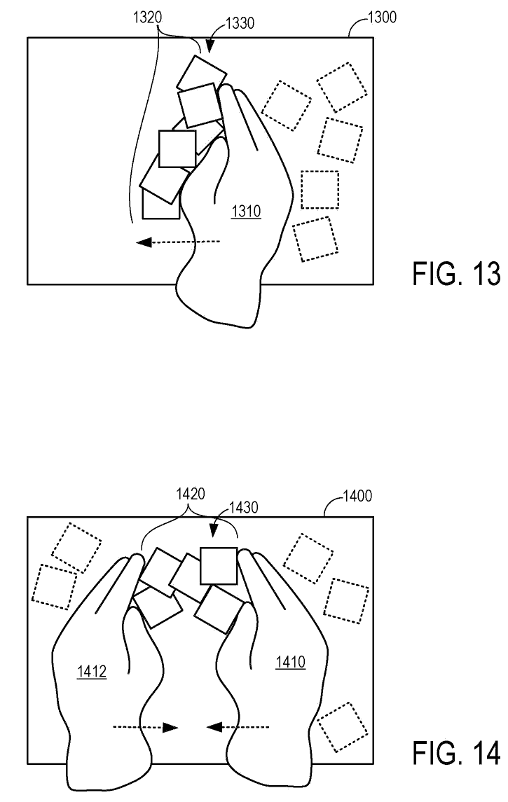

In some embodiments, a “scooping” gesture also may be used to form an overlapping arrangement of content items. FIGS. 13 and 14 depict examples where the touch gesture received at 210 includes such a “scooping” gesture. First, FIG. 13 depicts a touch gesture where a user uses a single hand to define a set of content items 1320 and to define a region 1330 of a touch-sensitive graphical user interface 1300 where an organizational container may be formed. FIG. 14 depicts a touch gesture comprising a multi-touch input where a user simultaneously uses a first hand 1410 and a second hand 1412 to define a set of content items 1420 and to define a region 1430 of a touch-sensitive graphical user interface 1400 where an organizational container may be formed.

In the above-described embodiments, it can be seen that a set of content items may be defined and then moved into an organizational container in various manners. As a more specific example, in some embodiments, content items are moved into the organizational container responsive to formation of the organizational container (e.g., at the time of formation of the organizational container). For example, as shown in FIG. 4, the set of content items 430 is moved into the organizational container responsive to the gesture that creates the organizational container. Likewise, in the embodiments of FIGS. 7 and 10-14, content may be moved into the organizational containers responsive to the same gesture that creates the organizational container.

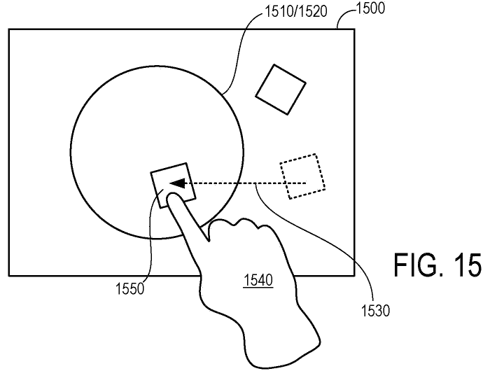

In other embodiments, the set of content items may be moved into the organizational container after formation of the organizational container and responsive to receiving at least a second touch gesture at the touch-sensitive graphical user interface after receiving the gesture that forms the organizational container. For example, the embodiments of FIGS. 8 and 9 show examples of gestures that form an organizational content into which content items may subsequently be moved. Further, FIG. 15 shows an organizational container 1610 into which a content item 1650 is moved via a second touch gesture (i.e. a touch gesture received after the gesture that formed the organizational container) in the form of a drag-and-drop gesture. It will be appreciated that each of the illustrative embodiments described herein enables the formation of an organizational container and the movement of content items into the organizational container via intuitive and easy-to-learn gestures, without the use of menus and other traditional graphical user interface controls.

It will be appreciated that the computing devices described herein may be any suitable computing device configured to execute the programs described herein other than the disclosed surface computing device. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

1. In a computing device including a touch-sensitive graphical user interface, a method of organizing content items presented on the touch-sensitive graphical user interface, comprising:
receiving a touch gesture at the touch-sensitive graphical user interface, the touch gesture defining a set of zero or more content items to be grouped together and further defining a region of the touch-sensitive graphical user interface;
forming an organizational container responsive to receiving the touch gesture at the touch-sensitive graphical user interface; presenting a boundary on the touch-sensitive graphical user interface at or near the region defined by the touch gesture, the boundary defining the organizational container;
moving the set of content items into the organizational container; and
presenting the set of content items on the touch-sensitive graphical user interface within the boundary defining the organizational container, the set of content items arranged within the boundary according to an organized view.

2. The method of claim 1, further comprising presenting a background canvas on the graphical user interface, wherein presenting the boundary includes presenting the boundary over the background canvas, the boundary including an internal region that exposes the background canvas.

3. The method of claim 1, where the touch gesture is defined by a path of travel of an object contacting the touch-sensitive graphical user interface, and wherein forming the organizational container responsive to the touch gesture includes forming the organizational container if the path of travel of the object corresponds to a recognized gesture.

4. The method of claim 3, where moving the set of content items into the organizational container is performed if the path of travel of the object substantially surrounds the set of content items.

5. The method of claim 3, where moving the set of content items into the organizational container is performed if the path of travel of the object contacts one or more content items of the set of content items or is within a threshold proximity to one or more content items of the set of content items.

6. The method of claim 3, wherein the recognized gesture is a line, wherein the line is defined by the path of travel of the object between a first content item of the set of content items and a second content item of the set of content items.

7. The method of claim 3, wherein the recognized gesture is a symbol, a geometric shape, or an alphanumeric character.

8. The method of claim 1, where moving the set of content items into the organizational container is performed responsive to formation of the organizational container.

9. The method of claim 1, further comprising, after formation of the organizational container, receiving a second touch gesture configured to move one or more content items into the organizational container.

10. The method of claim 1, where the organized view comprises one or more of a grouped stack of the set of content items or a tiled arrangement of the set of content items.

11. The method of claim 1, wherein defining a set of zero or more content items comprises moving two or more content items into an overlapping arrangement of content items.

12. The method of claim 11, further comprising determining whether the overlapping arrangement of content items comprises a number of content items greater than a threshold number of overlapping content items, and then forming the organization container only if the number of content items is greater than the threshold number.

13. A computing device, comprising: a touch-sensitive graphical user interface including a display system configured to present graphical content and a touch input device configured to receive a touch gesture responsive to an object contacting a display surface of the display system; a logic subsystem comprising a processor; and
memory comprising instructions stored thereon that are executable by the logic subsystem to operate the display system and the touch input device to:
receive a touch gesture at the touch input device, the touch gesture defining a set of content items to be grouped together and further defining a region of the display surface, the set of content items including zero or more content items presented on the display surface;
form an organizational container responsive to receiving the touch gesture at the touch input device;
present a boundary on the display surface at or near the region defined by the touch gesture, the boundary defining the organizational container;
move the set of content items into the organizational container; and
present the set of content items on the display surface within the boundary defining the organizational container, the set of content items arranged within the boundary according to an organized view.

14. The computing device of claim 13, where the memory further comprises instructions executable to form the organizational container if a path of travel of the object contacting the display surface corresponds to a recognized gesture.

15. The computing device of claim 14, wherein the recognized gesture is a symbol, a geometric shape, or an alphanumeric character.

16. The computing device of claim 13, where the memory further comprises instructions executable to move the set of content items into the organizational container only if a path of travel of the object contacting the display surface substantially surrounds the set of content items.

17. The computing device of claim 13, wherein the instructions are further executable to receive an input defining a set of content items by receiving a touch input moving content items into an overlapping arrangement, and to form an organizational container if the overlapping arrangement contains a number of content items exceeding a threshold number.

18. The computing device of claim 13, where the memory further comprises instructions stored thereon that are executable by the logic subsystem to operate the display system and the touch input device to: identify a proximity of two or more content items of the set of content items; and form the organizational container only if the proximity is less than a threshold proximity.

19. In a computing device including a touch-sensitive graphical user interface, a method of organizing content items presented on the touch-sensitive graphical user interface, the method comprising:
receiving a touch gesture at the touch-sensitive graphical user interface, the touch gesture defining a set of content items to be grouped together and further defining a region of the touch-sensitive graphical user interface, the set of content items including zero or more content items presented on the touch-sensitive graphical user interface;
forming an organizational container responsive to receiving the touch gesture at the touch-sensitive graphical user interface in response to the touch gesture;
presenting a boundary on the touch-sensitive graphical user interface at or near the region defined by the touch gesture, the boundary defining the organizational container and including an internal region that exposes a background canvas;
moving the set of content items into the organizational container; and
presenting the set of content items on the touch-sensitive graphical user interface within the boundary defining the organizational container, the set of content items arranged within the boundary according to an organized view.

20. The method of claim 19, further comprising, wherein the touch input is a first touch input, and further comprising receiving a second touch input that moves another content item into the organizational container.
